(19) United States
(12) Patent Application Publication
(10) Pub. No.: US 2003/0206020 A1
(43) Pub. Date: Nov. 6, 2003

(54) Systems and methods for a temperature controlled NMR probe

(76) Inventors: Tal Cohen, Herzlia (IL); Naim Levi, Ramat Hasharon (IL); Uri Rapoport, D.N. Merkaz (IL)

Correspondence Address: FOLEY HOAG, LLP, PATENT GROUP, WORLD TRADE CENTER WEST, 155 SEAPORT BLVD, BOSTON, MA, 02110, US

(21) Appl. No.: 10/137,539

(22) Filed: May 2, 2002

(51) Int. Cl. G01V 3/00

(52) U.S. Cl. 324/322; 324/315; 324/318

(57) ABSTRACT

A Nuclear Magnetic Resonance (NMR) probe including a temperature controlled body for providing a sample for NMR measurement such that the temperature controlled body can adapt to the sample temperature to substantially maintain the body temperature. The body encases a conduit that can contain the sample for NMR measurement. In an embodiment, the desired temperature is the operating temperature of the NMR. The body is also in communications with a temperature sensor, a heat exchanger such as a heat exchanger, and a processor that includes instructions for controlling the body temperature.

### FIELD

The disclosed systems and methods relate to nuclear magnetic resonance (NMR) testing and more particularly to NMR spectrometers probes.

### BACKGROUND

Nuclear magnetic resonance (NMR) testing of substances to determine the constituents therein is well known in the art. In known devices, the sample can be arranged between the poles of a magnet and enclosed by a wire coil to enable a sample to be subjected to RF electromagnetic pulses of a predetermined frequency. The resulting NMR pulse generated by the nuclei of the sample under test can be detected and processed by the NMR device in a well known manner to identify the sample constituents.

NMR analysis can be performed in devices commonly known as spectrometers. These spectrometers can have a probe that accepts the sample to be analyzed between poles of a magnet. The RF coils and tuning circuitry associated with the probe can create a magnetic field (B) that rotates the net magnetization of the nucleus. These RF coils also detect the transverse magnetization as it precesses in the X,Y plane. The RF coil can pulse the sample nucleus at the Lamor frequency to generate a readable signal for sample identification. An exemplary probe is disclosed in commonly owned U.S. Pat. No. 5,371,464 (Rapoport), and is incorporated herein by reference in its entirety.

A disadvantage of some probes includes the failure to react or respond to temperature changes of the sample, and particularly temperature increases caused by a sample where such temperature increases heat the magnet because of the strong thermal conductivity between the sample stream and the magnet. Samples are often presented to the probe at high temperatures to remain liquid for analysis, and to avoid gelling, solidifying or the like, if cooled. A sample can dissipate from within the probe and transfer to the ambient environment to ultimately reach the magnet and raise (or lower) the magnet's temperature. Heat from the sample may also be transferred by radiating through the ambient environment, and the sample temperature can be conducted through the probe material.

Since magnetic flux is proportional to magnet temperature, the magnet, upon heating (or other change of temperature) can undergo flux changes. These changes in flux can alter the homogeneity of the magnet, and thus the NMR results can be inaccurate, and in some cases, worthless.

Even a small change in sample stream temperature can be sufficient to cause a measurable change in magnetic flux. Frequency locks, such as that disclosed in U.S. Pat. No. 5,166,620 (Panosh), incorporated herein by reference in its entirety, can be introduced into probes to counter changes in flux, by controlling the frequency of the RF coils. As for changes in magnetic homogeneity, these can be made by shimming the magnet.

Currently, when magnet control is desired complex heat exchangers can be employed and placed in the path of the sample stream prior to its entry into the probe. This can be extremely costly and difficult to implement in in-line process environments.

Additionally, the temperature conductivity between the magnet and the sample stream can affect the sample itself. With the sample forced to remain in the probe for the desired testing time (period), the sample can change as its flow temporarily ceases during the analysis period. This temperature change can also affect the magnetic field and compromise NMR measurements.

### SUMMARY

A NMR probe can include a temperature controlled body for providing a sample for NMR measurement such that the temperature controlled body can be substantially maintained at a desired temperature, regardless of the temperature of a sample included in the body. By maintaining the temperature of the body at the operating temperature of the NMR, for example, the magnetic field may not be affected by the temperature of the sample.

The probe and/or body can include a temperature sensor that can provide a processor with a temperature measurement of the body. The processor can provide control instructions to a heat exchanger device to maintain the body at the desired temperature. A heat exchanger can be understood herein to represent a device that can heat and cool as desired. The processor can include a display and/or controls to allow a user to set the desired temperature of the body. In one embodiment, the temperature sensor and heat exchanger can be a single device, and for example, the temperature sensor and heat exchanger can include one or more commercially available heat pipes. Alternately, the temperature sensor and heat exchanger can be separate devices, and the temperature sensor can include, for example, a piezoelectric temperature sensor, a thermocouple, or another commercially available analog or digital temperature sensor. Similarly, the heat exchanger can be a commercially available heat exchanging device that can provide controlled heating and cooling.

In one embodiment, the NMR probe includes a body having a central opening and side openings adjacent the central opening, a conduit extending through the central opening in the body, a RF coil positioned along a portion of the conduit, and heat pipes disposed within the side openings to maintain the body at a predetermined temperature.

The body may include a base portion defining a base portion of the central opening and defining base portion grooves adjacent the base portion of the central opening, an end portion spaced apart from the base portion, the end portion defining an end portion of the central opening and defining end portion grooves adjacent the end portion of the central opening, side portions defining side portion grooves, the side portions secured to either side of the base portion and the end portion, the side portion grooves mating respectively with the base portion grooves and the end portion grooves to form the side openings, and covers extending between the base portion and the end portion and secured to the side portions to define a coil chamber wherein the RF coil is positioned.

The probe can include a frequency lock unit positioned within the chamber and in operative communication with the RF coil. A first pair of wire leads connected to the RF coil and a second pair of wire leads connected to the frequency lock unit may exit the chamber and extend on opposed faces of the base portion to respective terminations remote from the base portion. Control electronics connected to the respective terminations can operate the RF coil and the frequency lock unit.

The probe can include a base and flanges on the side portions to secure the side portions to the base. Adaptors can be inserted into opposite ends of the central opening and respectively extend from the central opening, with connectors secured to ends of the adaptors, the conduit extending through the adaptors and into the connectors.

The probe can include a thermoelectric cooler remote from the body to which the heat pipes can be attached or to which the heat pipes can otherwise communicate. Temperature control electronics can control the thermoelectric cooler to maintain the predetermined temperature within the probe. Insulation can be disposed on the heat pipes between the body and the thermoelectric cooler to minimize losses from the heat pipes.

### BRIEF DESCRIPTION OF THE DRAWINGS

FIG. 1A is a front view of one embodiment of a NMR probe;

FIG. 1B provides an expanded view of the chamber of FIG. 1A;

FIG. 2 is a cross sectional view taken along line 2-2 of FIG. 1;

FIG. 3 is a cross sectional view taken along line 3-3 of FIG. 1;

FIG. 4 is an isometric view of a side portion of the NMR probe of FIG. 1;

FIG. 5 is an isometric view of one middle portion of the NMR probe of FIG. 1;

FIG. 6 is an isometric view of another middle portion of the NMR probe of FIG. 1; and

FIG. 7 is a bottom view of the NMR probe of FIG. 1.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore features, components, modules, and/or aspects of the illustrations can be otherwise combined, separated, interchanged, and/or rearranged without departing from the disclosed systems or methods. Additionally, the shapes and sizes of components are also exemplary, unless otherwise provided, and can be altered without affecting the disclosed systems or methods.

The disclosed NMR probe includes a temperature controlled body for providing a sample for NMR measurement. The temperature controlled body can offset and/or counteract temperature effects of the sample on the magnetic field, such that the temperature of the body remains substantially constant regardless of the sample temperature. In one embodiment, the body includes or encases a conduit for presenting the sample for NMR. The probe can include at least one temperature sensor that can provide a processor with a temperature measurement of the body. In one embodiment, the temperature sensor(s) can be connected to or otherwise integrated with the body. Additionally and optionally, the temperature sensor(s) may not be connected to the body. The processor can be equipped with and provide control instructions to at least one heat exchanger to maintain the body at a desired temperature. The heat exchanger may also be integrated with or separate from the body. The processor can be in communications with a display and/or controls to allow a user to set the desired temperature of the body. In one embodiment, the temperature sensor and heat exchanger can be a single device. In one such embodiment, for example, the temperature sensor(s) and heat exchanger(s) can include one or more commercially available heat pipes. Alternately, the temperature sensor(s) and heat exchanger(s) can be separate devices, and the temperature sensor(s) can include, for example, a piezoelectric temperature sensor, a thermocouple, and/or another commercially available analog or digital temperature sensor(s). Similarly, the heat exchanger(s) can a commercially available heat exchanging device that can provide controlled heating and/or cooling.

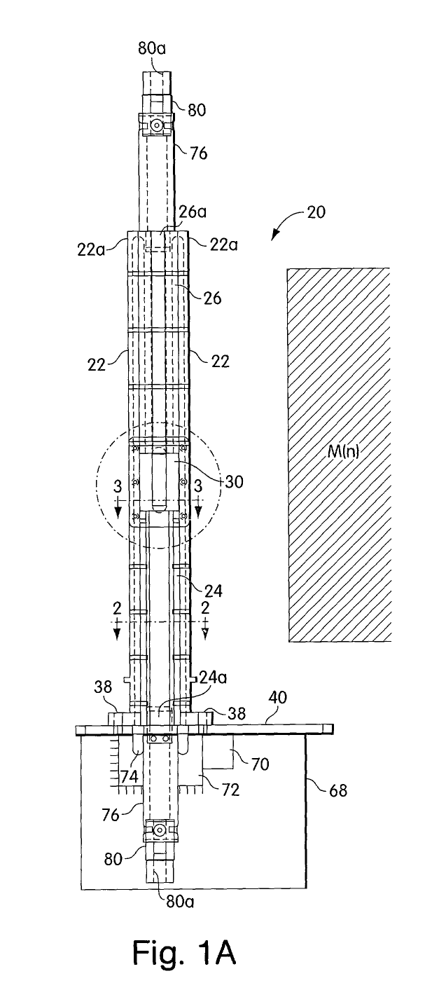

FIG. 1 shows generally one embodiment of an NMR probe 20 according to the probe disclosed herein where the body and temperature sensor/heat exchanger can be connected, although as provided herein, the disclosed apparatus is not limited to such an embodiment. The illustrated probe 20 is in use with a magnet M (typically having north “N” and south “S” poles), that generates a magnetic field (indicated by the vector B∘). The magnet M can be part of a system such as that detailed in U.S. Pat. No. 5,371,464, incorporated by reference herein in its entirety, designed to accommodate a probe, such as probe 20 of FIG. 1.

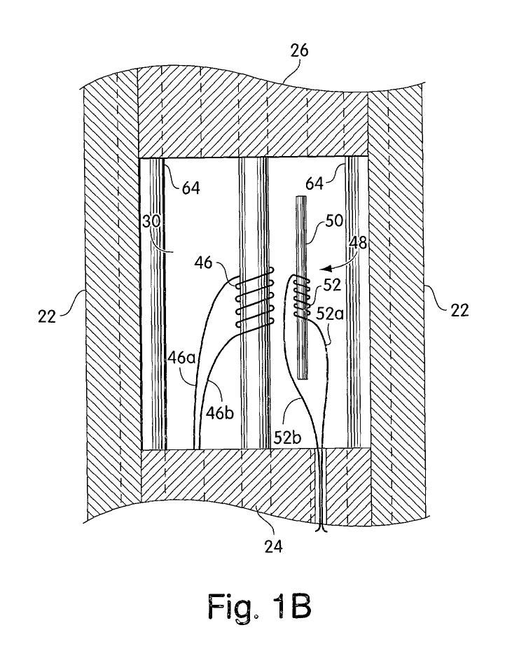

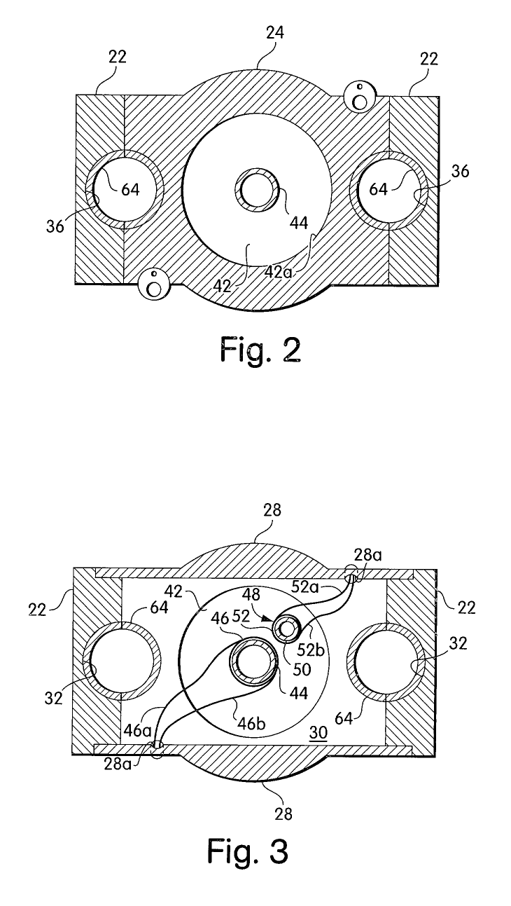

Referring also to FIGS. 2 and 3, showing cross-sectional views taken at lines 2-2 and 3-3 of FIG. 1, respectively, the FIG. 1 probe 20 includes two side portions 22 that can be secured one on either side of base middle portion 24 and end middle portion 26. In the illustrated embodiment, a gap exists between middle portions 24 and 26, however the gap is provided merely for convenience to provide access to components as described herein, and those with ordinary skill in the art will recognize that middle portion 24 and 26 can be continuous without providing a gap. Covers 28, not shown in FIG. 1 so as to illustrate additional features of probe 20, but shown in FIG. 3, can be secured between side portions 22 to enclose the gap between middle portions 24 and 26 so as to form chamber 30 enclosed by covers 28, side portions 22 and middle portions 24 and 26. As previously provided, chamber 30 is an optional feature of the probe 20.

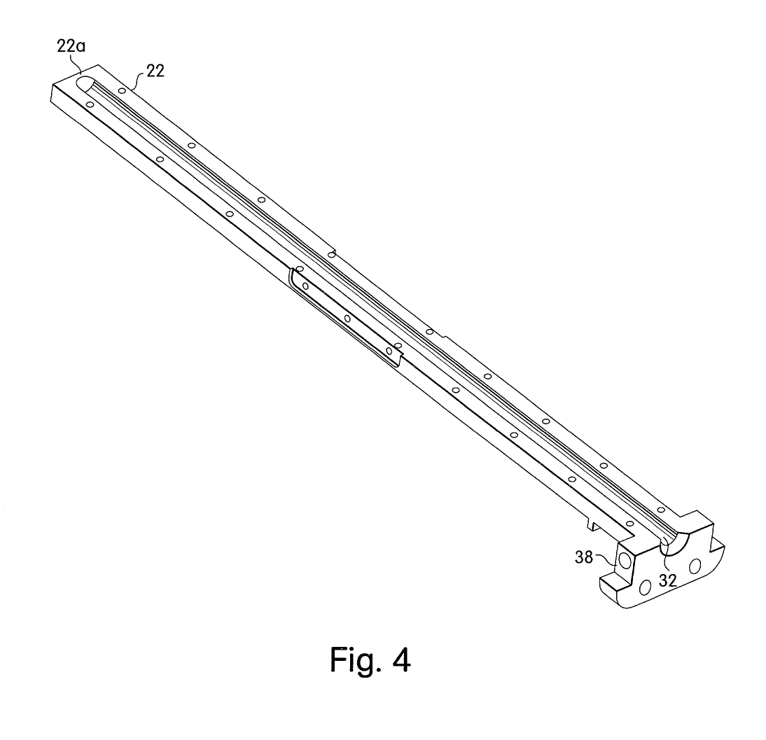

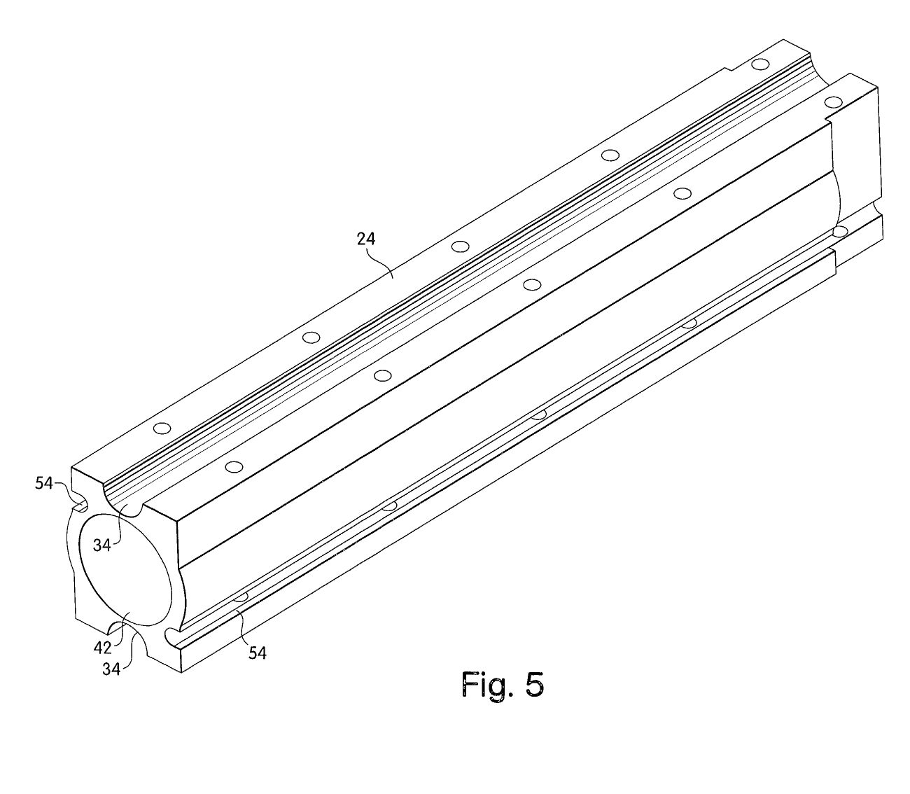

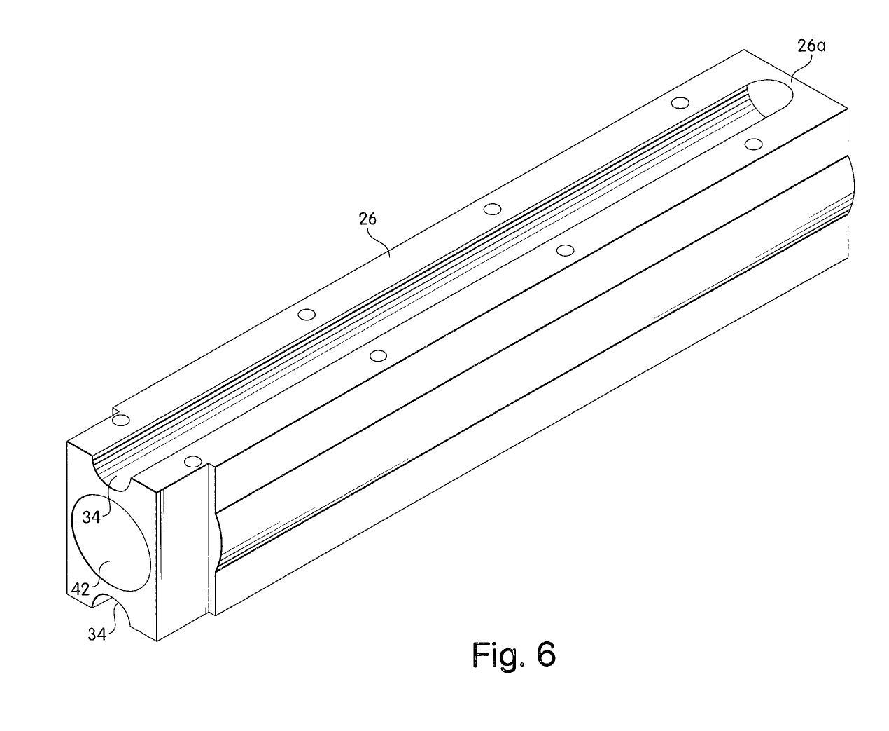

Referring now also to FIGS. 4, 5 and 6, isometric views of a side portion 22, base middle portion 24, and end middle portion 26 can be shown, respectively, for the FIG. 1 embodiment. Side portions 22 can have hemispherical grooves 32 disposed in inner faces thereof. Grooves 32 can mate with hemispherical grooves 34 in either side of middle portions 24 and 26 to form cylindrical openings 36 (FIGS. 2 and 3) when side portions 22 are secured to middle portions 24 and 26. Side portions 22 can include flange ends 38 that can secure probe 20 to base 40. Grooves 32, 34 can extend longitudinally from flange ends 38 to near opposite ends 22a, 26a of side portions 22 and end middle portion 26, respectively, such that ends 22a, 26a form a closure for cylindrical openings 36.

Middle portions 24, 26 can include central cylindrical opening 42 that extend longitudinally through middle portions 24, 26 and can be disposed between hemispherical grooves 34. A conduit 44 (FIGS. 2 and 3) through which the sample to be analyzed passes can extend through the cylindrical opening 42. In the illustrated embodiment, there can be space between the conduit 44 and the inner wall 42a of cylindrical opening 42, however this is optional. At chamber 30, an RF coil 46 preferably journals the conduit 44 along a non-magnetic, preferably non-metallic, portion of the conduit 44. It can be seen that side portions 22 and middle portions 24, 26 can be fabricated as a single unit, with appropriate bores therethrough, and a cut-out provided for chamber 30. As provided previously herein, in such an embodiment, covers may not be provided.

Conduit 44 can be a glass tube for containing samples at high pressures and temperatures. Other non-magnetic, non-metallic materials, such as ceramics and sapphire can also be suitable provided they are treated to hold samples at desired pressures. The illustrated conduit 44 allows the RF coil 46 to be placed around it, so as to journal it, in either a contacting or non-contacting manner, or combinations thereof (contacting and non-contacting portions). As provided herein, conduit 44 can allow a fluid or other sample to pass through conduit.

Also at chamber 30, field or frequency lock unit or mechanism 48, which can include a sealed sample 50 journaled by a field or frequency lock RF coil 52, and associated electronics, preferably can be part of the probe 20, but are not required. The frequency lock unit 48 can be, for example, in accordance with that detailed in commonly owned U.S. Pat. No. 5,166,620 (Panosh), incorporated by reference herein in its entirety.

RF Coil 46 and frequency lock RF coil 52 terminate in wires 46a, 46b, 52a, 52b, respectively, that connect to control electronics (detailed below). Pairs of wires, i.e., wires 46a, 46b and wires 52a, 52b can be laid in respective feed grooves 54 disposed in opposite faces of base middle portion 24, i.e., the faces over which covers 28 are secured, and extending the length of base middle portion 24. Covers 28 can have a corresponding groove 28a where pairs of wires 46a, 46b and 52a, 52b exit from chamber 30. Wires 46a, 46b, 52a, 52b preferably can be silver plated copper wires, with one wire of a pair being insulated from the other. Though illustrated in separate feed grooves 54, wires 46a, 46b, 52a, 52b can be laid in a single groove, or can be secured to outside faces of middle portion 24, to end portions 22, or to another convenient surface or location. Additionally, wires 46a, 46b, 52a, 52b can be fed through central opening 42, provided appropriate consideration is given to the elevated temperature of the sample within conduit 44.

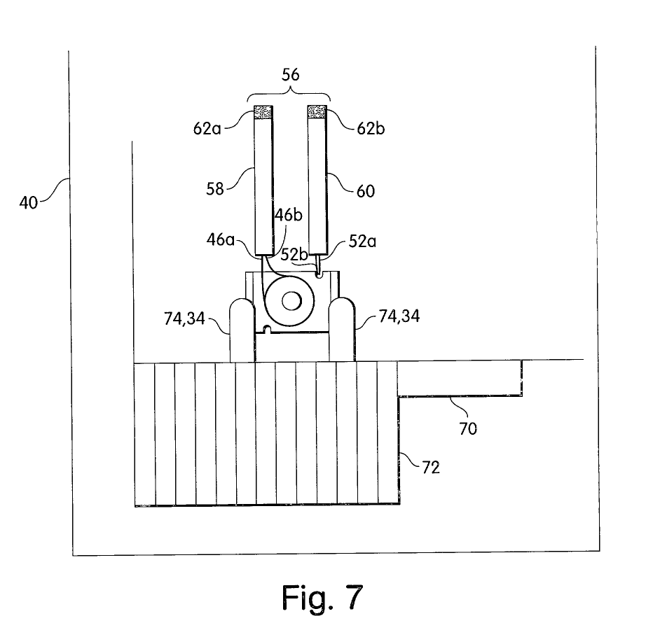

Referring to FIG. 7, an illustrative bottom view of probe 20 shows control electronics 56. The wires 46a, 46b, 52a, 52b can extend through base 40, connecting to the control electronics that are partially on lands 58, 60. Lands 58, 60 correspond to control electronics for the RF coil 46 and frequency lock RF coil 52, respectively. The base 40 can also include connection ports 62a, 62b, such as SMA, for example, Part No. 2006-5010-00 from MA COM, Massachusetts, for permitting connections to the control electronics 56 located on the lands 58, 60, by cables, wires or the like. There are typically at least two connection ports 62a, 62b, corresponding to main RF coil 46 and field or frequency lock RF coil 52, respectively. The control electronics 56 can be, for example, in accordance with that detailed in commonly owned U.S. Pat. No. 6,310,480 (Cohen et al.), incorporated by reference herein in its entirety. Other control electronics having processors with instructions for controlling the operation of RF coil 46 and frequency lock RF coil 52, as are known in the art, can be utilized.

As noted previously, heat from a sample within conduit 44 can affect the magnetic flux of magnets M and thus affect the results obtained. The FIG. 1 apparatus can be temperature controlled to minimize the temperature effects of the sample on the magnets and/or the magnetic field produced by the magnets. Means for dissipating heat from the sample in conduit 44 can be incorporated within cylindrical openings 36. Heat transferred from the sample within conduit 44 to side portions 22 and middle portions 24, 26 can be removed from cylindrical openings through base 40. Thus, heat radiated from side portions 22 and middle portions 24, 26 can be reduced to minimize heat effects on magnets M.

In one embodiment, as illustrated in the figures, heat pipes 64 can be disposed within cylindrical openings 36 and extend the length of openings 36, between flange ends 38, through base 40, and to heat pipe controller 68. Heat pipe controller 68 can include temperature control electronics 70 and thermoelectric cooler 72, whereby the temperature within probe 20 can be maintained substantially at a predetermined temperature. Insulation 74 can be provided about heat pipes 64 on exposed portions of heat pipes 64, i.e., generally between flange ends 38 and controller 68. It can be appreciated that in maintaining a predetermined temperature, heat pipe controller 68 may also be utilized as a sensing device, i.e., by determining the heat load to be dissipated, the temperature of the sample, or conduit 44 can also be determined, or alternately, by determining the temperature of the body, the amount of heat/cooling to be provided can be determined. Temperature control electronics 70 can include a processor with instructions for causing the processor to act in accordance with the systems disclosed herein. Temperature control electronics 70 can also include a display and keys, touchpads, or another mechanism for providing user-input to the temperature control electronics 70.

The sample within conduit 44 can maintain a temperature that is different enough (either higher or lower) than the operating temperature of the NMR device (and/or magnet), to adversely affect the NMR device. Utilizing a temperature controlling technology, such as heat pipe technology, can allow the body to be maintained at substantially a constant temperature that corresponds to the operating temperature of magnet M. Heat from conduit 44 can be transferred to middle portions 24 and 26 through opening 42. Heat pipes 64 may transfer appropriate cooling to middle portions 24 and 26 and also to side portions 22, such that temperatures within side and middle portions 22, 24, 26 can be maintained within specified tolerances. Although illustrated embodiments utilize heat pipes because of their rapid response time, other technologies can be used to control the temperature of the body. As an example, heat transfer coils or fins can be used, but such examples are provided merely for illustration and not limitation, and other commercially available mechanisms for providing heat transfer can be used without departing from the scope of the methods and systems disclosed herein. It may also be recognized that other arrangements and numbers of heat pipes 64 about the conduit 44 can be used. For example, heat pipes 64 can be coiled about conduit 44, or can be placed about the exterior of the body.

As an example of a heat pipe design, a conduit 44 may have an outer diameter of 6 mm and a sample to be tested may have a temperature of 120° C. The heat power from conduit 44 can be transferred through opening 42 to middle portions 24, 26 and opening 42 can have an interior diameter of 12 mm. Heat pipes 64 can be maintained at a constant temperature in the range of 40° C. to 45° C. Heat transfer by natural convection between two coaxial cylinders can be calculated using a heat transfer coefficient h is equal to:

$$h = \frac{Nu \cdot λ}{d} ,$$

, where: Nu is the Nusselt number, λ is the thermal conductivity of air and d is the characteristic diameter. The Nusselt number is equal to Nu=0.317 (Gr·Pr)1/4 0.89, where Gr is the Grashof number and Pr is the Prandtl number, as are known in the art.

For the embodiment illustrated in the figures, the characteristic diameter can be determined from d=0.5(d₂−d₁), where d1 and d2 are the outer diameter of conduit 44 and inner diameter opening 42, respectively. Using known values for the Grashof number and the Prandtl number, the Nusselt number can be determined to be Nu=0.94, and thus h=8.1 watts/m2-° C. For the parameters given, the total convective heat load can be found: QCON=4.5 watts.

Heat transfer by radiation can be calculated from the Stefan-Boltzmann equation Q_{RAD}=σ(T₁⁴−T₂⁴), where σ is the Stefan-Boltzmann constant and T1, T2 are the absolute temperatures of the conduit 44 and the middle portions 24, 26, respectively. For the parameters given, QRAD=5.6 watts. The total heat transfer between the conduit 44 and the middle portions 24, 26 is the sum of the convection and radiation heat transfers QTOT=QCON+QRAD=10.1 watts. A thermoelectric cooler 72 having a 29 watt cooling power can provide quick and accurate temperature stabilization. In this example, using a 1.5 mm minimum wall thickness for side and middle portions 22, 24, 26, and the above parameters, a computer simulation can be conducted to determine a maximum temperature of 45.1° C. at the exterior of probe 20.

Adaptors 76 can fit within central cylindrical opening 42 at ends 24a and 26a of middle portions 24, 26, respectively. In the FIG. 1 embodiment, for example, adaptors 76 can be threaded into opening 42, though it will be understood that other means of attaching adaptors 76 into opening 42 can be used, e.g., press fitting, adhesion, fastening, and the like. Connectors 80 can be secured to adaptors 76 and conduit 44 may extend through adaptors 76 and may mate into bore 80a of connectors 80. In a one embodiment, adaptors 76 can be made of a plastic material and connectors 80 can be made of stainless steel, although other materials can be used in accordance with the application.

In operation, a temperature-controlled probe such as the FIG. 1 probe 20 can be subjected to a magnetic field provided by a magnet as detailed in U.S. Pat. No. 5,371,464. Cables can then be connected to the SMA connectors 62a, 62b. For the FIG. 1 embodiment, heat pipe controller 68 can be configured to maintain probe 20 at the desired temperature. The sample can then be introduced to or entered into the probe 20, and may either flow through the conduit 44 or may remain in a non-flowing manner in the conduit 44, while NMR analysis is performed. The NMR analysis, including operation of the RF coil 46 and optional frequency lock RF coil 52, including pulse sequence protocols, can be in accordance with conventional NMR analysis. By using the temperature control mechanism as described, the temperature effects of the sample on the magnetic field can be minimized, if not eliminated, by allowing the temperature control sensor and device, or in this embodiment the heat pipes, to maintain the temperature of the probe body at substantially the same temperature (e.g., desired operating temperature of magnet/NMR). As provided previously herein, the temperature control electronics 56 can be equipped to allow a user or other to input or otherwise designate the operating temperature.

While the method and systems have been disclosed in connection with the illustrated embodiments, various modifications and improvements thereon will become readily apparent to those skilled in the art. For example, the structure provided herein included a mostly rectangular body with a circular conduit, etc. Those with ordinary skill in the art will recognize that such shapes and sizes are merely for illustrative purposes, and can be varied accordingly based on application without departing from the scope of the disclosed methods and systems. Accordingly, the body can be cylindrical, spherical, square, or another shape, and is not limited to the rectangular shape provided in the illustrated embodiment. The conduit and openings for the conduit can similarly be another shape besides the circular (cross-section) shape provided herein, and can be rectangular, triangular, square, etc., for example. For the illustrated embodiment that utilizes heat pipes, for example, the heat pipes 64 can be located at other locations or can be replaced entirely with another sensor/controller or set of sensors/controllers. The heat pipes or other sensor and/or heat exchanger are not required to be placed in cylindrical or other particularly shaped grooves or openings, and such grooves or openings, if used, are not required to coincide with the entire length of the body as provided in the illustrated embodiment. Furthermore, in an embodiment where grooves or openings are used, such grooves or openings can be another shape than the shape provided herein. The connection between the processor and the sensor/controller can be wired or wireless or can be through a wired or wireless network. The aforementioned changes are also merely illustrative and not exhaustive, and other changes can be implemented without affecting the ability of the probe to include a body that is temperature controlled. Accordingly, many additional changes in the details, materials, and arrangement of parts, herein described and illustrated, can be made by those skilled in the art. It will thus be understood that the following claims are not to be limited to the embodiments disclosed herein, can include practices otherwise than specifically described, and are to be interpreted as broadly as allowed under the law.

What is claimed is:

1. A Nuclear Magnetic Resonance (NMR) probe, comprising:
a conduit to contain a sample;
a body to encase the conduit; and
a heat exchanger to substantially maintain the body at a predetermined temperature.

2. A NMR probe according to claim 1, comprising:
a processor, and,
instructions to cause the processor to control the heat exchanger.

3. A NMR probe according to claim 1, wherein the heat exchanger includes at least one of: at least one heat pipe, at least one heat transfer coil, and at least one heat fin.

4. A NMR probe according to claim 1, further including a temperature sensor.

5. A NMR probe according to claim 4, wherein the temperature sensor is in communications with the processor.

6. A NMR probe according to claim 1, wherein the heat exchanger provides temperature measurements of the body.

7. A NMR probe according to claim 1, wherein the heat exchanger is not connected to the body.

8. A NMR probe according to claim 1, wherein the heat exchanger is connected to the body.

9. A NMR probe according to claim 1, further including a RF coil that journals at least a portion of the conduit.

10. A NMR probe according to claim 9, further including a frequency lock unit in communications with the RF coil.

11. A Nuclear Magnetic Resonance (NMR) probe, comprising:
a body having a central opening and side openings adjacent the central opening;
a conduit extending through the central opening in the body, the conduit for containing a sample;
heat pipes in thermal conductivity with the body to substantially maintain the body at a predetermined temperature.

12. A NMR probe according to claim 11, wherein,
the body includes side openings adjacent the central opening, and,
the heat pipes are disposed within the side openings.

13. A NMR probe according to claim 11, further including a RF coil that journals at least a portion of the conduit.

14. A NMR probe according to claim 11, wherein the body comprises:
a base portion defining a base portion of the central opening and defining base portion grooves adjacent the base portion of the central opening;
an end portion spaced apart from the base portion, the end portion defining an end portion of the central opening and defining end portion grooves adjacent the end portion of the central opening; and,
side portions defining side portion grooves, the side portions secured to either side of the base portion and the end portion, the side portion grooves mating respectively with the base portion grooves and the end portion grooves to form the side openings.

15. A NMR according to claim 13, wherein the body further includes covers extending between the base portion and the end portion and secured to the side portions to define a coil chamber wherein the RF coil is positioned.

16. A NMR probe according to claim 15, comprising a frequency lock unit positioned within the chamber and in operative communication with the RF coil.

17. A NMR probe according to claim 16, comprising:
a first pair of wire leads connected to the RF coil; and
a second pair of wire leads connected to the frequency lock unit, the first pair and the second pair of wire leads respectively exiting from the coil chamber and extending on opposed faces of the base portion to respective terminations remote from the base portion.

18. A NMR probe according to claim 17, comprising control electronics connected to the respective terminations of the first pair and the second pair of wire leads, the control electronics operating the RF coil and the frequency lock unit.

19. A NMR probe according to claim 14, comprising:
abase; and
flanges on the side portions to secure the side portions to the base.

20. A NMR probe according to claim 11, comprising:
adaptors inserted into opposite ends of the central opening and respectively extending from the central opening; and
connectors secured to ends of the adaptors remote from the body, the connectors defining respective conduit openings for receiving the conduit, the conduit extending through the adaptors and into the connectors.

21. A NMR probe according to claim 11, comprising:
temperature control electronics remote from the body;
a thermoelectric cooler remote from the body and adjacent the temperature control electronics, the heat pipes extending from the body and connected to the thermoelectric cooler, the temperature control electronics controlling the thermoelectric cooler to substantially maintain the predetermined temperature; and
insulation disposed on the heat pipes between the body and the thermoelectric cooler.

22. A method for performing NMR on a sample, the method comprising:
introducing the sample through a conduit, the conduit encased by a body, and,
controlling the temperature of the body.

23. A method according to claim 22, wherein controlling the temperature of the body includes substantially maintaining the body temperature at a desired temperature.

24. A method according to claim 22, wherein controlling the temperature of the body includes sensing the temperature of the body.

25. A method according to claim 22, wherein controlling the temperature of the body includes providing a processor with instructions to control a heat exchanger to substantially maintain the body at a desired temperature.

26. A method according to claim 22, wherein controlling the temperature of the body includes utilizing at least one heat pipe, at least one heat transfer coil, and at least one heat fin.
